(19) United States
(12) Patent Application Publication
(10) Pub. No.: US 2016/0135090 A1
(43) Pub. Date: May 12, 2016

(54) MILLIMETER WAVELENGTH BASE STATION BEAMFORMING TECHNIQUE ADVERTISING AND EFFICIENT USER EQUIPMENT TRANSMISSION STRATEGY

(71) Applicant: QUALCOMM Incorporated, San Diego, CA (US)

(72) Inventors: Parthasarathy Krishnamoorthy, San Diego, CA (US); Ashwin Sampath, Skillman, NJ (US); Sundar Subramanian, Bridgewater, NJ (US); Anand Rajurkar, Hyderabad (IN); Prashanth Mohan, Hyderabad (IN); Aravinth Rajendran, Hyderabad (IN)

(21) Appl. No.: 14/932,887

(22) Filed: Nov. 4, 2015

Related U.S. Application Data
(60) Provisional application No. 62/076,779, filed on Nov. 7, 2014.

(51) Int. Cl. H04W 28/18; H04W 16/28; H04W 52/02; H04W 72/04

(52) U.S. Cl. CPC H04W 28/18; H04W 72/048; H04W 16/28; H04W 52/0261

(57) ABSTRACT

Methods, systems, and apparatuses are described for advertising information corresponding to beamforming techniques supported by base stations of a wireless communications system, which in various examples may include analog, digital, and/or hybrid beamforming techniques supported by millimeter wave (mmW) base stations. Advertising of supported beamforming techniques may involve transmissions over a nearby long term evolution (LTE) or another carrier frequency network (e.g., in case of LTE/lower carrier frequency assisted mmW wireless access networks). Alternatively or additionally, advertising may employ broadcasting from a mmW base station, which may include mmW beam sweeps. A UE may receive information corresponding to supported beamforming techniques, and may use the received information to select a particular mmW base station with which to communicate or to determine a transmission strategy for communicating with a particular mmW base station, or both.

### CROSS REFERENCES

The present Application for Patent claims priority to U.S. Provisional Patent Application No. 62/076,779 by Krishnamoorthy et al., entitled “Millimeter Wavelength Base Station Capability Advertising and Efficient User Equipment Transmission Strategy,” filed Nov. 7, 2014, assigned to the assignee hereof, and expressly incorporated by reference herein.

### BACKGROUND

1. Field of the Disclosure

The present disclosure relates to wireless communication systems, and more particularly to the advertising of information corresponding to beamforming techniques supported by millimeter wavelength (mmW) base stations.

2. Description of Related Art

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

By way of example, a wireless multiple-access communication system may include a number of base stations, each simultaneously supporting communication for multiple communication devices, where each device may be referred to as a user equipment (UE). A base station may communicate with UEs on downlink channels (e.g., for transmissions from a base station to a UE) and uplink channels (e.g., for transmissions from a UE to a base station).

Communication systems may employ a licensed radio frequency spectrum band, a shared radio frequency spectrum band, or both. Communication over a shared millimeter wavelength mmW radio frequency spectrum in the higher gigahertz (GHz) band, for example, may be promising for multi-gigabit wireless communication. Compared to other lower frequency systems, the radio frequency spectrum around 60 GHz holds several advantages including an increased bandwidth in a shared radio frequency spectrum band, compact size of a transceiver due to small wavelength (about 5 mm), and relatively lower interference due to high atmospheric absorption. However, there are several challenges associated with this radio frequency spectrum band, such as reflection and scattering losses, high penetration loss and high path loss, which limit the range of coverage around 60 GHz. To overcome this issue, directional transmission may be employed. Thus, in some examples a technique known as beamforming utilizing multi-element antenna arrays may be employed for mmW wireless communication.

For beamforming, base stations may employ analog, digital, or hybrid beamforming techniques. UEs also may employ such beamforming techniques. However, base stations and UEs may possess different beamformer architecture (e.g., those architectures that support analog, digital, or hybrid beamforming techniques). As the beamforming techniques supported by base stations are not known by UEs a priori, the UE may be unable to determine an efficient transmission strategy for communication with a particular base station. This may result in performance degradation for the UE, particularly for establishing a communications link with a mmW base station.

### SUMMARY

The described features generally relate to one or more improved systems, methods, and/or apparatuses for advertising of information corresponding to beamforming techniques supported by one or more base stations, where one or more of the base stations may employ a mmW radio frequency spectrum band. For example, beamforming techniques supported by a base station (e.g., one or more types of beam forming supported—analog, digital or hybrid) may be advertised, and such advertising may be received by UEs that may subsequently perform wireless communications with the base station. The advertising may be accomplished through a long term evolution (LTE) or other carrier frequency network, which in various examples may be part of a transmission in a radio frequency spectrum band at a lower frequency than those bands associated with mmW communications. Alternatively or additionally, a mmW base station may broadcast information corresponding to supported beamforming techniques by way of a mmW transmission, such as through mmW beam sweeps. In some examples, beam sweeps may be performed by way of beamforming sweeps employing one or more antennas or antenna arrays, such as a mmW antenna array. A UE may receive the information corresponding to one or more beamforming techniques supported by one or more base stations, and in some examples may use the received information to select a particular base station with which to communicate. The UE may also use the receive information to determine a transmission strategy for communicating with a particular base station.

A method for wireless communication is described. The method may include: receiving, at a user equipment (UE), information corresponding to one or more beamforming techniques supported by a first millimeter wavelength (mmW) base station; and determining a transmission strategy for communication with the first mmW base station based at least in part on the received information.

An apparatus for wireless communications is described. The apparatus may include a processor, memory in electronic communication with the processor, and instructions stored in the memory. The instructions may be executable by the processor to cause the apparatus to: receive, at a user equipment (UE), information corresponding to one or more beamforming techniques supported by a first millimeter wavelength (mmW) base station; and determine a transmission strategy for communication with the first mmW base station based at least in part on the received information.

Another apparatus for wireless communication is described. The apparatus may include: means for receiving, at a user equipment (UE), information corresponding to one or more beamforming techniques supported by a first millimeter wavelength (mmW) base station; and means for determining a transmission strategy for communication with the first mmW base station based at least in part on the received information.

A non-transitory computer-readable medium storing code for wireless communications is described. The code may include instructions executable to cause an apparatus to: receive, at a user equipment (UE), information corresponding to one or more beamforming techniques supported by a first millimeter wavelength (mmW) base station; and determine a transmission strategy for communication with the first mmW base station based at least in part on the received information.

In some examples of the method, apparatuses, or non-transitory computer readable medium the one or more beamforming techniques supported by the first mmW base station include an analog beamforming technique, a digital beamforming technique, or a hybrid beamforming technique, or a combination thereof.

In some examples of the method, apparatuses, or non-transitory computer readable medium, determining the transmission strategy for communication with the first mmW base station may include steps, features, means, or instructions for selecting one of an analog beamforming technique, a digital beamforming technique, or a hybrid beamforming technique for transmission to the first mmW base station.

Some examples of the method, apparatuses, or non-transitory computer readable medium may include steps, features, means, or instructions for performing a discovery communication with the first mmW base station using the determined transmission strategy.

Some examples of the method, apparatuses, or non-transitory computer readable medium may include steps, features, means, or instructions for identifying at least one UE-specific factor, and determining the transmission strategy for communication with the first mmW base station based at least in part on the at least one UE-specific factor. In some examples of the method, apparatuses, or non-transitory computer readable medium, the at least one UE-specific factor may include a power level associated with a battery of the UE, a storage level of a battery of the UE, a resource availability of the UE, an application employed at the UE or a service employed at the UE, or a combination thereof. In some examples of the method, apparatuses, or non-transitory computer readable medium, the resource availability of the UE may include an antenna availability or a radio frequency chain availability, or a combination thereof.

Some examples of the method, apparatuses, or non-transitory computer readable medium may include steps, features, means, or instructions for receiving at least one transmission parameter for the UE from the first mmW base station and determining the transmission strategy for communication with the first mmW base station based at least in part on the at least one transmission parameter.

Some examples of the method, apparatuses, or non-transitory computer readable medium may include steps, features, means, or instructions for receiving at least one other station-specific factor, and determining the transmission strategy for communication with the first mmW base station based at least in part on the at least one other station-specific factor.

In some examples of the method, apparatuses, or non-transitory computer readable medium, receiving information corresponding to one or more beamforming techniques supported by the first mmW base station may include steps, features, means, or instructions for receiving a broadcast transmission from the first mmW base station.

In some examples of the method, apparatuses, or non-transitory computer readable medium, receiving information corresponding to one or more beamforming techniques supported by the first mmW base station may include steps, features, means, or instructions for receiving a transmission employing a radio access technology other than mmW.

Some examples of the method, apparatuses, or non-transitory computer readable medium may include steps, features, means, or instructions for receiving, at the UE, information corresponding to one or more beamforming techniques supported by a second mmW base station, and selecting the first mmW base station for communication therewith based at least in part on the information corresponding to one or more beamforming techniques supported by the first mmW base station and the information corresponding to one or more beamforming techniques supported by the second mmW base station.

A method for wireless communication is described. The method may include: advertising, from a millimeter wavelength (mmW) base station, information corresponding to one or more beamforming techniques supported by the mmW base station.

An apparatus for wireless communications is described. The apparatus may include a processor, memory in electronic communication with the processor, and instructions stored in the memory. The instructions may be executable by the processor to cause the apparatus to: advertise, from a millimeter wavelength (mmW) base station, information corresponding to one or more beamforming techniques supported by the mmW base station.

Another apparatus for wireless communication is described. The apparatus may include: means for advertising, from a millimeter wavelength (mmW) base station, information corresponding to one or more beamforming techniques supported by the mmW base station.

A non-transitory computer-readable medium storing code for wireless communications is described. The code may include instructions executable to cause an apparatus to: advertise, from a millimeter wavelength (mmW) base station, information corresponding to one or more beamforming techniques supported by the mmW base station.

In some examples of the method, apparatuses, or non-transitory computer readable medium the one or more beamforming techniques supported by the mmW base station may include an analog beamforming technique, a digital beamforming technique, or a hybrid beamforming technique, or a combination thereof.

In some examples of the method, apparatuses, or non-transitory computer readable medium, advertising information corresponding to one or more beamforming techniques supported by the mmW base station may include steps, features, means, or instructions for: transmitting the information corresponding to one or more beamforming techniques supported by the mmW base station by employing a radio access technology other than mmW.

In some examples of the method, apparatuses, or non-transitory computer readable medium, advertising information corresponding to one or more beamforming techniques supported by the mmW base station may include steps, features, means, or instructions for broadcasting the information corresponding to one or more beamforming techniques supported by the mmW base station.

In some examples of the method, apparatuses, or non-transitory computer readable medium, advertising information corresponding to one or more beamforming techniques supported by the mmW base station may include steps, features, means, or instructions for the mmW base station to perform a beam sweep.

Some examples of the method, apparatuses, or non-transitory computer readable medium, may include steps, features, means, or instructions for receiving a discovery communication from a UE, the discovery communication having a transmission strategy based at least in part on the advertised information corresponding to one or more beamforming techniques supported by the mmW base station.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example of a wireless communication system, in accordance with aspects of the present disclosure;

FIG. 2 shows a swim diagram illustrating various actions and communications between a UE and a base station, in accordance with aspects of the present disclosure;

FIG. 3A shows a block diagram of an apparatus configured for use in wireless communication, in accordance with aspects of the present disclosure;

FIG. 3B shows a block diagram of an apparatus configured for use in wireless communication, in accordance with aspects of the present disclosure;

FIG. 4 shows a block diagram of an apparatus configured for use in wireless communication, in accordance with aspects of the present disclosure;

FIG. 5 shows a block diagram illustrating an example of an architecture of a UE configured for use in wireless communication, in accordance with aspects of the present disclosure;

FIG. 6 shows a block diagram illustrating an example of an architecture of a base station configured for use in wireless communication, in accordance with aspects of the present disclosure;

FIG. 7 shows a flowchart illustrating an example of a method for wireless communication that may be implemented by a UE, in accordance with aspects of the present disclosure;

FIG. 8 shows a flowchart illustrating an example of a method for wireless communication that may be implemented by a UE, in accordance with aspects of the present disclosure;

FIG. 9 shows a flowchart illustrating an example of a method for wireless communication that may be implemented by a UE, in accordance with aspects of the present disclosure;

FIG. 10 shows a flowchart illustrating an example of a method for wireless communication that may be implemented by a base station, in accordance with aspects of the present disclosure; and

FIG. 11 shows a flowchart illustrating an example of a method for wireless communication that may be implemented by a base station, in accordance with aspects of the present disclosure.

### DETAILED DESCRIPTION

As described above, base stations and UEs may perform communications by employing a mmW radio frequency spectrum band, and may possess different beamformer architecture (analog, digital or hybrid). It may be useful for a UE to know the beamforming techniques supported by a base station to determine an efficient transmission strategy for communicating with the base station. Further, it may be useful for a UE to know the beamforming techniques supported by a plurality of base stations to allow the UE to select a suitable base station with which the UE may communicate. In some examples, this knowledge may be advantageous for those base stations and/or UEs that employ a mmW radio frequency spectrum band. The UE may achieve increased performance with minimal power/resource consumption using the determined transmission strategy, the selected base station, or both.

A wireless communications system may employ an advertisement of beamforming techniques supported by one or more base stations (e.g., type of beam forming supported—analog, digital or hybrid) to UEs of the wireless communications system. For example, a mmW base station may advertise information corresponding to one or more beamforming techniques supported by one or more mmW base stations, which in some examples may include an advertisement of the advertising mmW base station's own supported beamforming techniques. In some examples, such advertising may be accomplished through a long term evolution (LTE) or other carrier frequency network, which in various examples may be part of a transmission in a radio frequency spectrum band at a lower frequency than those radio frequency spectrum bands associated with mmW communications. Alternatively or additionally, a mmW base station may broadcast information corresponding to supported beamforming techniques by way of a mmW transmission, such as through mmW beam sweeps.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with reference to various examples may be combined in other examples.

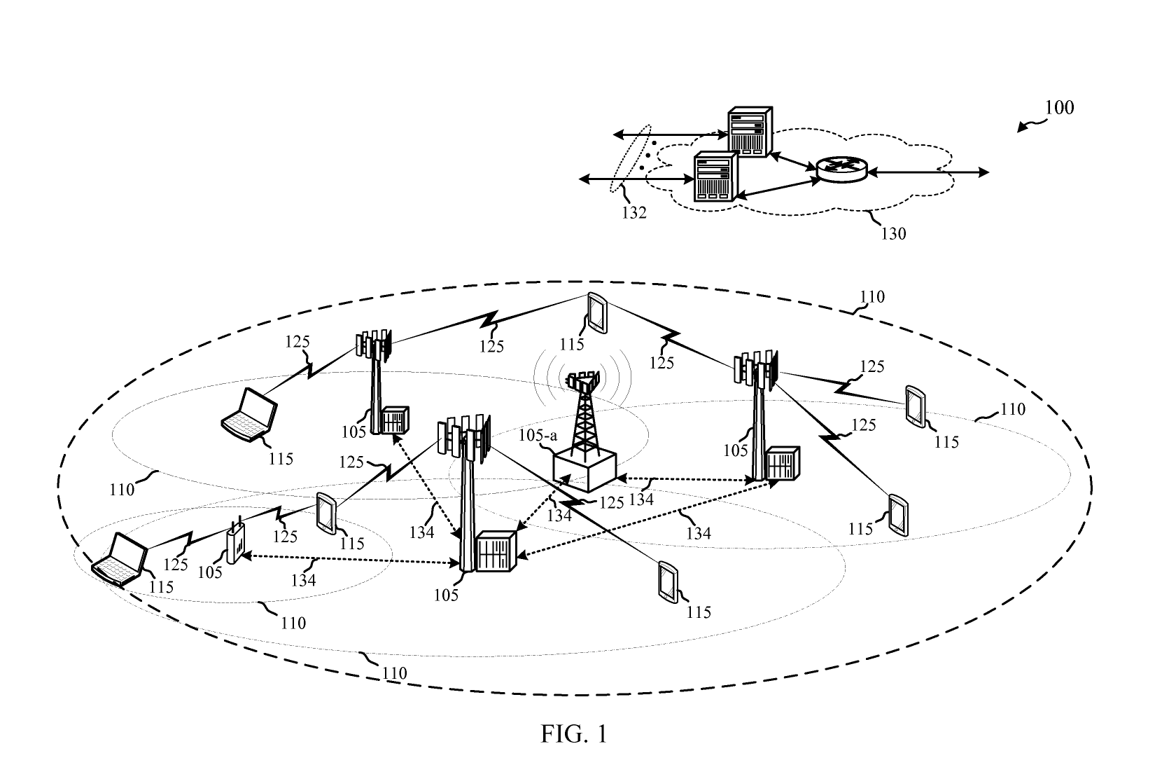

FIG. 1 illustrates an example of a wireless communications system 100 in accordance with aspects of the present disclosure. The wireless communications system 100 includes base stations 105, UEs 115, and a core network 130. The core network 130 may provide user authentication, access authorization, tracking, Internet Protocol (IP) connectivity, and other access, routing, or mobility functions. The base stations 105 may interface with the core network 130 through backhaul links 132 (e.g., S1, etc.) and may perform radio configuration and scheduling for communication with the UEs 115, or may operate under the control of a base station controller (not shown). In various examples, the base stations 105 may communicate, either directly or indirectly (e.g., through core network 130), with each other over backhaul links 134 (e.g., X1, etc.), which may be wired or wireless communication links.

The base stations 105 may wirelessly communicate with the UEs 115 via one or more base station antennas. In some examples, base station antennas may be located within one or more base station antenna arrays. One or more base station antennas or base station antenna arrays may be collocated at an antenna assembly, such as an antenna tower. Additionally or alternatively, base station antennas or base station antenna arrays associated with a base station 105 may be located in diverse geographic locations. In various examples a base station 105 may use multiple base station antennas or base station antenna arrays to conduct beamforming operations for directional communications with one or more UEs 115.

Each of the base stations 105 may provide communication coverage for a respective geographic coverage area 110. In the example shown, one or more of the base stations 105 may utilize a shared mmW radio frequency spectrum band, which in some examples may be an unlicensed radio frequency spectrum band. Each of the base stations 105 that support communications over a mmW radio frequency spectrum band may be referred to as a mmW base station. Further, in this example, the base station 105-a may additionally utilize a different radio access technology, such as LTE, and may be referred to as a base transceiver station, a radio base station, an access point, a radio transceiver, a NodeB, eNodeB (eNB), Home NodeB, a Home eNodeB, or some other suitable terminology. The geographic coverage area 110 for a base station 105 may be divided into sectors making up only a portion of the coverage area (not shown). The wireless communications system 100 may include base stations 105 of different types (e.g., macro and/or small cell base stations). Each of the base stations 105 may be configured to communicate using one or more communication technologies, and there may be overlapping geographic coverage areas 110 for different technologies.

In this example, the wireless communications system 100 is an LTE-assisted mmW wireless access network. The term evolved Node B (eNB) may be used to describe the base station 105-a, while the term UE may be generally used to describe the UEs 115. The wireless communications system 100 may be a heterogeneous network in which base stations provide coverage for various geographical regions. While a single base station 105-a is shown for simplicity, there may be multiple base stations 105-a that provide the geographic coverage area 110-a to cover all or a subset of the UEs within the wireless communications system 100. The geographic coverage areas 110 may indicate communication coverage for a macro cell, a small cell, and/or other types of cell. The term “cell” is a 3GPP term that can be used to describe a base station, a carrier or component carrier associated with a base station, or a coverage area (e.g., sector, etc.) of a carrier or base station, depending on context.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, dedicated, unlicensed, shared, etc.) frequency bands as macro cells. Small cells may include pico cells, femto cells, and micro cells according to various examples. A pico cell may cover a relatively smaller geographic area and may allow unrestricted access by UEs with service subscriptions with the network provider. A femto cell also may cover a relatively small geographic area (e.g., a home) and may provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. A base station may support one or multiple (e.g., two, three, four, and the like) cells (e.g., component carriers).

The wireless communications system 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

Communication networks that may accommodate some of the various disclosed examples may be packet-based networks that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer also may use Hybrid ARQ (HARM) to provide retransmission at the MAC layer to improve link efficiency. In the control plane, the Radio Resource Control (RRC) protocol layer may provide establishment, configuration, and maintenance of an RRC connection between a UE 115 and the base stations 105 or core network 130 supporting radio bearers for the user plane data. At the Physical (PHY) layer, the transport channels may be mapped to Physical channels.

The UEs 115 are dispersed throughout the wireless communications system 100, and each UE 115 may be stationary or mobile. A UE 115 also may include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with various types of base stations and network equipment including macro base stations, small cell base stations, relay base stations, and the like.

In the example shown, communication links 125 may include uplink (UL) transmissions from a UE 115 to a base station 105, and/or downlink (DL) transmissions, from a base station 105 to a UE 115. The downlink transmissions may be referred to as forward link transmissions, and the uplink transmissions may be referred to as reverse link transmissions. Each communication link 125 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication links 125 may transmit bidirectional communications using frequency-division duplexing (e.g., using paired spectrum resources) or time-division duplexing operation (e.g., using unpaired spectrum resources). Frame structures for frequency-division duplexing (e.g., frame structure type 1) and time-division duplexing (e.g., frame structure type 2) may be defined.

In various embodiments of the wireless communications system 100, the base stations 105 and/or the UEs 115 may include multiple antennas for employing beamforming to improve communication quality, reliability, and/or efficiency between the base stations 105 and UEs 115. Further, the base station 105-a may include multiple antennas to provide various broadcasting capabilities, which may include broadcasting of different radio access technologies (RATs).

As described above, the wireless communications system 100 may include an advertising of information corresponding to one or more beamforming techniques supported by one or more of the base stations 105. For example, a base station 105 may broadcast information corresponding to beamforming techniques supported by the base station 105, and/or any of the other base stations 105, in a manner such that one or more of the UEs 115 within the wireless communications system 100 may receive such information. In various examples advertised information corresponding to supported beamforming techniques may be received by a UE even though a communication link 125 has not been established between a UE 115 and a base station 105. Thus, the UEs 115 may receive information corresponding to one or more beamforming techniques supported by one or more of the base stations 105 prior to discovery and association procedures.

In some examples, a base station 105 may broadcast information corresponding to supported beamforming techniques. In some examples, a base station 105 may perform a beam sweep to transmit information corresponding to one or more supported beamforming techniques, where in some examples a beam sweep may employ beamforming at multiple antennas or an antenna array to direct and/or concentrate transmissions along various selected directions. In some examples, a base station 105 may advertise information corresponding to one or more supported beamforming architectures by way of a transmission in a mmW radio frequency spectrum band, which may be a mmW broadcast or a mmW beam sweep.

Additionally or alternatively, base stations 105 may transmit information corresponding to one or more beamforming techniques supported by one or more of the base stations 105 to the base station 105-a, for example, using backhaul links 134. In various examples the base station 105-a may broadcast information corresponding to beamforming techniques supported by one or more of the base stations 105 in a manner in which the information may be received by the UEs 115. Advertisement of the beamforming techniques supported by one or more of the base stations 105 may be implementation specific as well, and may employ any of the above mechanisms, or some other mechanism as well.

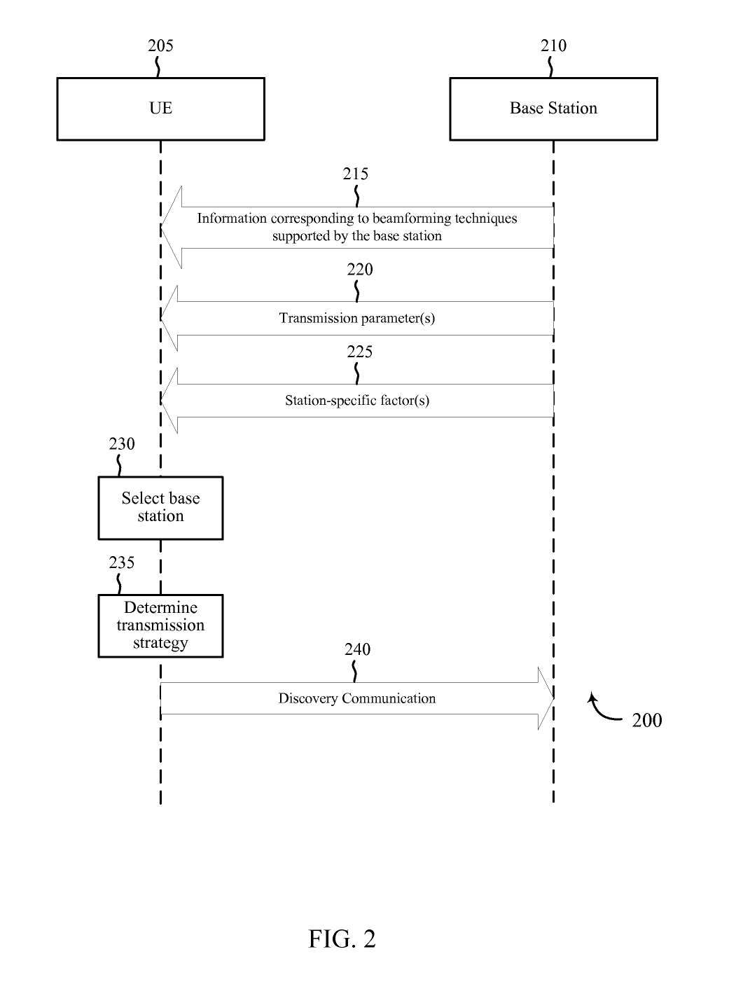

FIG. 2 shows a swim diagram 200 illustrating various actions and communications between a UE 205 and a base station 210, in accordance with aspects of the present disclosure. In some examples, the base station 210 may be a mmW base station, and both the UE 205 and the base station 210 may be configured for communications over one or more mmW radio frequency spectrum bands. A first communication 215 including information corresponding to one or more beamforming techniques supported by the mmW base station may be received by the UE 205. Although the first communication 215 is shown as a transmission from the base station 210, in various other examples the first communication 215 may be a transmission from a different base station (not shown). In various examples the first communication 215 may be a transmission employing a mmW radio frequency spectrum band, or may be a transmission employing a different radio access technology (RAT), such as LTE.

In some examples, the UE 205 may also receive information corresponding to beamforming techniques supported by one or more other base stations (not shown), such that the UE 205 receives information corresponding to one or more beamforming techniques supported by a plurality of base stations. In various examples the UE 205 may receive the information corresponding to the one or more beamforming techniques supported by the plurality of base stations as individual transmissions from each respective base station, and in various examples the UE 205 may receive information corresponding to beamforming techniques supported by more than one base station as a transmission from a single base station. Transmission (e.g., broadcast) of the information corresponding to supported beamforming techniques may be periodic, for example, to reach the UE 205 as it moves within a transmission range of the base station 210.

In some examples an optional second communication 220 including at least one transmission parameter may be received by the UE 205. In various examples the transmission parameter may include one or more of, but is not limited to, power, transmission power offset, timing, coding, frequency, or the like. Although the optional second communication 220 is shown as a transmission from the base station 210, in other examples the optional second communication 220 may be a transmission from a different base station (not shown).

In some examples an optional third communication 225 including at least one station-specific factor may be received by the UE 205. In various examples the station-specific factor may include, but is not limited to, location information, signal strength information, available frequencies, or the like. Although the optional third communication 225 may be a transmission from the base station 210, in other examples the optional third communication 225 may be a transmission from a different base station (not shown).

In some examples, the UE 205 may optionally perform an action 230 to select the base station 210 from a plurality of base stations based on the received information corresponding to the one or more beamforming techniques supported by the plurality of mmW base stations. In some examples a selection may be based solely on the information corresponding to supported beamforming techniques of the base stations, and in some examples a selection may be additionally be based on one or more UE-specific factors. In some examples, where applicable, the selection may be additionally based on one or more station-specific factors received by the UE 205, such as station-specific factors included in the optional third communication 225.

The UE 205 may perform an action 235 to determine a transmission strategy for communication with the base station 210 based on the received information. Determining the transmission strategy may involve selecting a beamforming technique for the UE 205 to employ for communications with the base station 210, which in some examples may follow the selection of the base station 210 for communications. In various examples, the selected beamforming technique may include an analog beamforming technique, a digital beamforming technique, or a hybrid beamforming technique.

In some examples, where applicable, determining the transmission strategy may include a determination based on a transmission parameter that is received from the base station 210, such as a transmission parameter included in the optional second communication 220. In some examples, where applicable, determination may be additionally based on one or more station-specific factors received by the UE 205, such as station-specific factors included in the optional third communication 225.

The UE 205 may transmit a fourth communication 240, such as a discovery or association request to the base station 210 using the determined transmission strategy. Thus, the UE 205 may perform such a communication in an efficient manner, even though the handshake of the discovery process or the association of the UE 205 with the base station 210 has yet to occur. In general, the UE 205 may choose a transmission strategy accordingly, which may result in higher performance of the UE 205 and may reduce resource/power consumption.

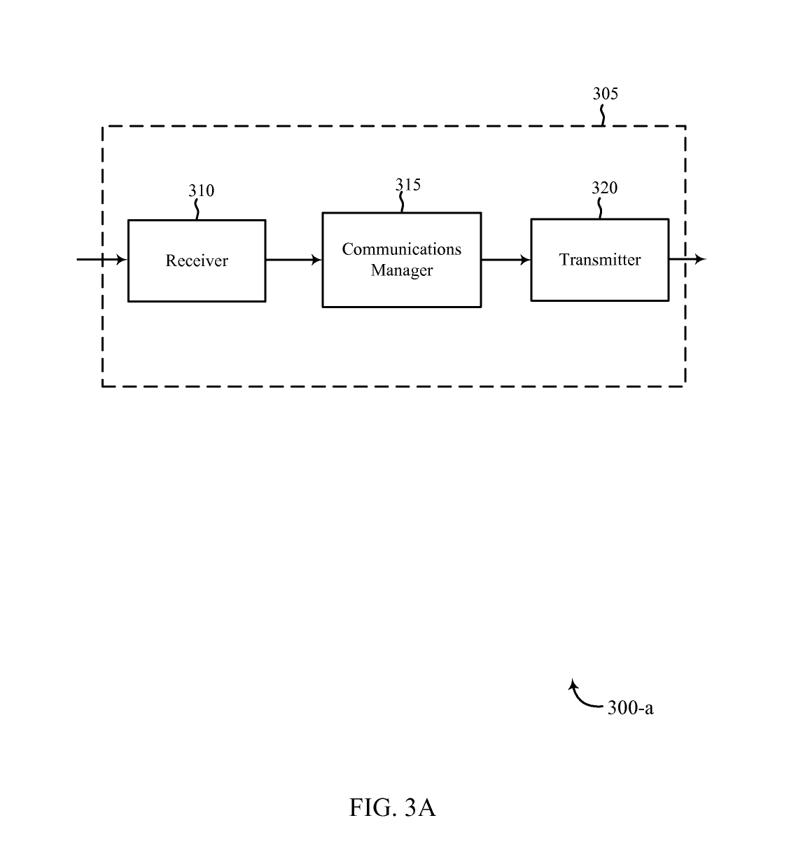

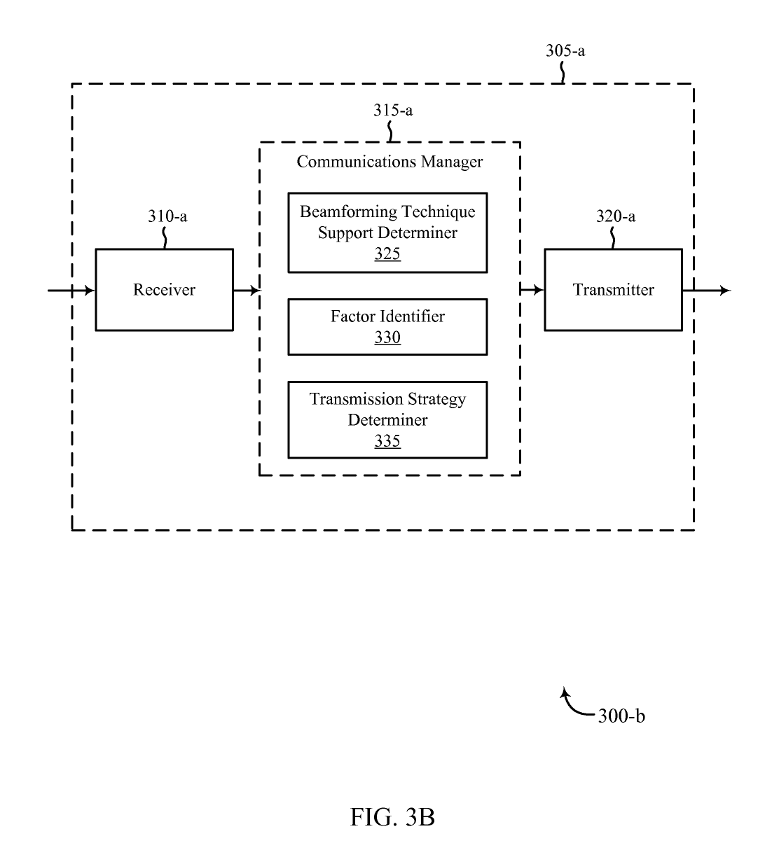

FIG. 3A shows a block diagram 300 of an apparatus 305 configured for use in wireless communication, in accordance with aspects of the present disclosure. The apparatus 305 may be an example of one or more aspects of a UE 115 as described with reference to FIG. 1, or a UE 205 as described with reference to FIG. 2. The apparatus 305 may include a receiver 310, a communications manager 315, and/or a transmitter 320. In some examples the apparatus 305 may include a processor (not shown). Each of these components may be in communication with each other.

The components of the apparatus 305 (as well as those of other related apparatuses described herein) may, individually or collectively, be implemented using one or more application-specific integrated circuits (ASICs) adapted to perform some or all of the applicable functions in hardware. Additionally or alternatively, the functions may be performed by one or more other processing units (or cores), on one or more integrated circuits. In various examples one or more other types of integrated circuits may be used (e.g., a Structured/Platform ASICs, a Field Programmable Gate Array (FPGA), and/or other Semi-Custom ICs), which may be programmed in any manner known in the art. The functions of each module also may be implemented, in whole or in part, with instructions embodied in a memory, formatted to be executed by one or more general or application-specific processors.

The receiver 310 may receive information such as packets, user data, and/or control information associated with various information channels (e.g., control channels, data channels, etc.). In various examples the receiver 310 may include all or part of one or more transceivers of a UE 115 and/or one or more antennas of a UE 115. In some examples the receiver 310 may be configured to receive signals in a mmW radio frequency spectrum band, and/or other radio frequency spectrum bands, such as radio frequency spectrum bands associated with an LTE communications system.

In some examples, the receiver 310 may be configured to wirelessly receive information corresponding to one or more beamforming techniques supported by one or more base stations 105, which may include beamforming techniques supported by one or more mmW base stations. The receiver 310 may receive the information with or without additional information such as transmission parameters or other station-specific factors for transmission strategy determination and/or selection of a base station 105 for subsequent communication. In various examples the receiver 310 may receive information corresponding to supported beamforming techniques from the respective base stations 105, or from another base station 105, such as the base station 105-a described with reference to FIG. 1. In various examples the information corresponding to supported beamforming techniques may be received in a mmW transmission, or in a transmission employing a different RAT. Information received by the receiver 310 may be passed on to the communications manager 315, and to other components of the apparatus 305.

The communications manager 315 may be configured to identify, act on, or otherwise process the information corresponding to the one or more beamforming techniques supported by the one or more base stations (as well as any other information, such as transmission parameters, station-specific factors, etc.). As described herein, the communications manager 315 may determine a transmission strategy for communicating with a base station 105 based at least in part on the information corresponding to supported beamforming techniques (and in some examples, where applicable, based on other information including any one or more of a received transmission parameter, a received station-specific parameter, or a UE-specific factor). In some examples, where applicable, the communications manager 315 may select a base station 105 from a plurality of base stations 105 with which to communicate, and in some examples the selected base station 105 may be a mmW base station. The communications manager 315 may implement at least a portion of the determined transmission strategy using the transmitter 320.

The transmitter 320 may transmit one or more signals received from other components of the apparatus 305, including those generated within the apparatus 305, and including those under control of the communications manager 315. For example, the transmitter 320 may be configured to transmit information to a base station 105 to perform a discovery process and associate the apparatus 305 with the base station 105 (e.g., establish a communication link with the base station 105 for data communications, such as communication link 125 as described with reference to FIG. 1).

In various examples the transmitter 320 may include all or part of one or more transceivers of a UE 115 and/or one or more antennas of a UE 115, and in various examples a determined transmission strategy employed by the transmitter 320 may include an analog, digital, or hybrid beamforming technique. In various examples, the transmitter 320 may be configured to transmit signals in a mmW radio frequency spectrum band, and/or other radio frequency spectrum bands, such as radio frequency spectrum bands associated with an LTE communications system or some other RAT.

FIG. 3B shows a block diagram 300-b of an apparatus 305-a configured for use in wireless communication, in accordance with aspects of the present disclosure. The apparatus 305-a may be an example of one or more aspects of UEs 115 described with reference to FIG. 1, UE 205 described with reference to FIG. 2, or apparatus 305 described with reference to FIG. 3A. The apparatus 305-a may include a receiver 310-a, a communications manager 315-a, and/or a transmitter 320-a. The apparatus 305 also may include a processor (not shown). Each of these components may be in communication with each other.

The components of the apparatus 305-a (as well as those of other related apparatus described herein) may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each module also may be implemented, in whole or in part, with instructions embodied in a memory, formatted to be executed by one or more general or application-specific processors.

The receiver 310-a and the transmitter 320-a may operate similarly to the receiver 310 and the transmitter 320, respectively, as described with reference to FIG. 3A. The communications manager 315-a may perform similar operations as the communications manager 315 described with reference to FIG. 3A. In some examples the communications manager 315-a may include a beamforming technique support determiner 325, a factor identifier 330 and/or a transmission strategy determiner 335. While shown as part of the communications manager 315-a, these components may be separate, such as separate elements of code and/or separate processing elements, and these components may cooperate with the communications manager 315-a, the receiver 310-a and/or the transmitter 320-a, as appropriate or desired.

The beamforming technique support determiner 325 may receive information corresponding to one or more beamforming techniques supported by one or more base stations from the receiver 310-a, which in various examples may include mmW beamforming techniques supported by a mmW base station. The beamforming technique support determiner may process such information to identify the beamforming techniques supported by respective base stations 105. The beamforming technique support determiner 325 also may determine the beamforming techniques supported by the apparatus 305-a, for example, by information regarding the transmitter 320-a, where such information may be available either directly from the transmitter 320-a or from information stored or otherwise determined by the communications manager 315-a.

The factor identifier 330 may receive information from the receiver 310-a, such as station-specific factors, which in some examples may have been received from the base station(s) 105. The factor identifier 330 may process such information to identify the factors for respective base stations 105. Additionally or alternatively, the factor identifier 330 may receive information from various other components of the apparatus 305-a to identify device-specific (e.g., UE-specific) factors. The device-specific factors may include, but are not limited to, a power level associated with a battery of the apparatus 305-a, a storage level of a battery of the apparatus 305-a, a resource availability of the apparatus 305-a (e.g., an antenna availability, a radio frequency chain availability, or the like), an application employed at the apparatus 305-a, a service employed at the apparatus 305-a, or the like.

The transmission strategy determiner 335 may receive the information corresponding to supported beamforming techniques (processed as needed to associate the support of beamforming techniques with respective base stations 105, for example) as well as the beamforming techniques supported by the apparatus 305-a from the beamforming technique support determiner 325. In some examples the transmission strategy determiner 335 may receive factors (whether device-specific or station-specific) from the factor identifier 330. The transmission strategy determiner 335 may determine a suitable transmission strategy based on one or more of the beamforming techniques supported by a base station 105, the beamforming techniques supported by the apparatus 305-a, or the factors, as appropriate or desired. For example, in some examples the transmission strategy determiner 335 may determine a transmission strategy employing a mmW radio frequency spectrum band, and in some examples the transmission strategy determined 335 may select a beamforming technique such as an analog beamforming technique, a digital beamforming technique, or a hybrid beamforming technique for communication with a mmW base station. As described with reference to FIG. 2, for example, the transmission strategy determiner 335 may also determine a transmission strategy based in part on a transmission parameter, such as one received from a base station 210.

In some examples the transmission strategy determiner 335 (or another portion of the communications manager 315-a) may select a base station 105 from a plurality of base stations 105 to use for data communications based on the based on information corresponding to beamforming techniques supported by the plurality of base stations, and in some examples additionally based in part on one or more of the beamforming techniques supported by the apparatus 305-a, device-specific factors, station-specific factors, or transmission parameters, as appropriate or desired. The transmission strategy determiner 335 may then determine a suitable transmission strategy for communications with the selected base station 105. In some examples the transmission strategy determiner 335 may determine a transmission strategy for communications with each of the base station(s) 105 for which information corresponding to supported beamforming techniques has been received, and then cause the corresponding transmission strategy for the selected base station 105 to be implemented by the apparatus 305-a.

The determined transmission strategies for communications with the base stations may be stored locally at the apparatus 305-a. Then, absent updated information from the base station(s) 105, the apparatus 305-a may re-evaluate and re-select a base station 105 based on a change in circumstances at the apparatus 305-a, and implement the corresponding stored transmission strategy. Alternatively or additionally, the apparatus 305-a may have the transmission strategies updated based on the change in circumstances. The change in circumstances may involve a change in the location of the apparatus 305-a, a change in power level associated with a battery of the apparatus 305-a, a change in storage level of a battery of the apparatus 305-a, or a change in any other device-specific factors or station-specific factors considered for base station selection and/or transmission strategy determination.

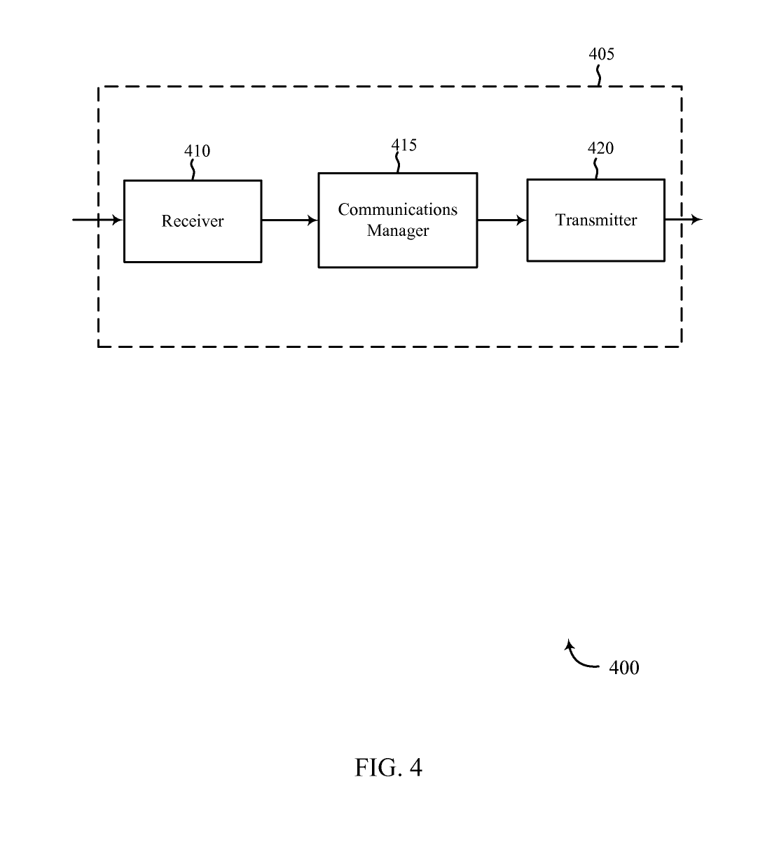

FIG. 4 shows a block diagram 400 of an apparatus 405 configured for use in wireless communication, in accordance with aspects of the present disclosure. The apparatus 405 may be an example of one or more aspects of a base station 105 as described with reference to FIG. 1, or a base station 210 as described with reference to FIG. 2. In some examples the apparatus 405 may be an example of a mmW base station. The apparatus 405 may include a receiver 410, a communications manager 415, and/or a transmitter 420. In some examples the apparatus 405 may include a processor (not shown). Each of these components may be in communication with each other.

The components of the apparatus 405 (as well as those of other related apparatus described herein) may, individually or collectively, be implemented using one or more application-specific integrated circuits (ASICs) adapted to perform some or all of the applicable functions in hardware. Additionally or alternatively, the functions may be performed by one or more other processing units (or cores), on one or more integrated circuits. In various examples one or more other types of integrated circuits may be used (e.g., a Structured/Platform ASICs, a Field Programmable Gate Array (FPGA), and/or other Semi-Custom ICs), which may be programmed in any manner known in the art. The functions of each module also may be implemented, in whole or in part, with instructions embodied in a memory, formatted to be executed by one or more general or application-specific processors.

The receiver 410 may receive information such as packets, user data, and/or control information associated with various information channels (e.g., control channels, data channels, etc.). In various examples the receiver 410 may include all or part of one or more transceivers of a base station 105 and/or one or more antennas of a base station 105, and the receiver 410 may be configured to receive signals in a mmW radio frequency spectrum band, and/or other radio frequency spectrum bands, such as radio frequency spectrum bands associated with an LTE communications system.

In some examples, the receiver 410 may be configured to receive information corresponding to one or more beamforming techniques supported by one or more other base stations 105, which may include one or more mmW base stations. The receiver 410 may receive the information with or without additional information such as transmission parameters or other station-specific factors for transmission strategy determination and/or selection of a base station 105 for communication. In some examples the receiver 410 may be configured to receive a discovery communication from a UE, which may be a beamformed mmW transmission from a UE. In some examples the discovery communication may have a transmission strategy based on information advertised by a base station 105, which may include information advertised by the apparatus 405. Information received by the receiver 410 may be passed on to the communications manager 415, and to other components of the apparatus 405.

The communications manager 415 may be configured to identify, act on, or otherwise process the information received or otherwise determined in the apparatus 405. For example, the communications manager may determine one or more beamforming techniques supported by one or more base stations. In some examples the communications manager may determine supported beamforming techniques of the apparatus 405 by communicating with one or both of the receiver 410 or the transmitter 420. In some examples, the communications manager may determine beamforming techniques supported by other base stations 105 by way of information received by the receiver 410. The communications manager may also manage aspects of other portions of communication with various devices, such as the establishment of a communications link with a UE, such as communication links 125 described with reference to FIG. 1, a communication link with another base station such as a backhaul links 134 described with reference to FIG. 1, or a communications link with a core network such as backhaul links 132. The communications manager 415 may implement various transmissions and transmission strategies using the transmitter 420.

The transmitter 420 may transmit one or more signals received from other components of the apparatus 405, including those generated within the apparatus 405, and including those under control of the communications manager 415. For example, the transmitter 420 may be configured to advertise information corresponding to one or more beamforming techniques supported by one or more base stations 105, which may include a beamforming technique supported by the apparatus 405. In various examples, the transmitter 420 may be configured to advertise the information by one or both of a broadcast or a beam sweep, and may advertise the information by way of a mmW or any other radio frequency spectrum band, such as a radio frequency spectrum band associated with an LTE communications system.

In various examples the transmitter 420 may include all or part of one or more transceivers of a base station 105 and/or one or more antennas of a base station 105, and a transmission strategy employed by the transmitter 420 may include an analog, digital, or hybrid beamforming technique. In various examples, the transmitter 420 may be configured to transmit signals in a mmW radio frequency spectrum band, and/or other radio frequency spectrum bands, such as radio frequency spectrum bands associated with an LTE communications system or some other RAT.

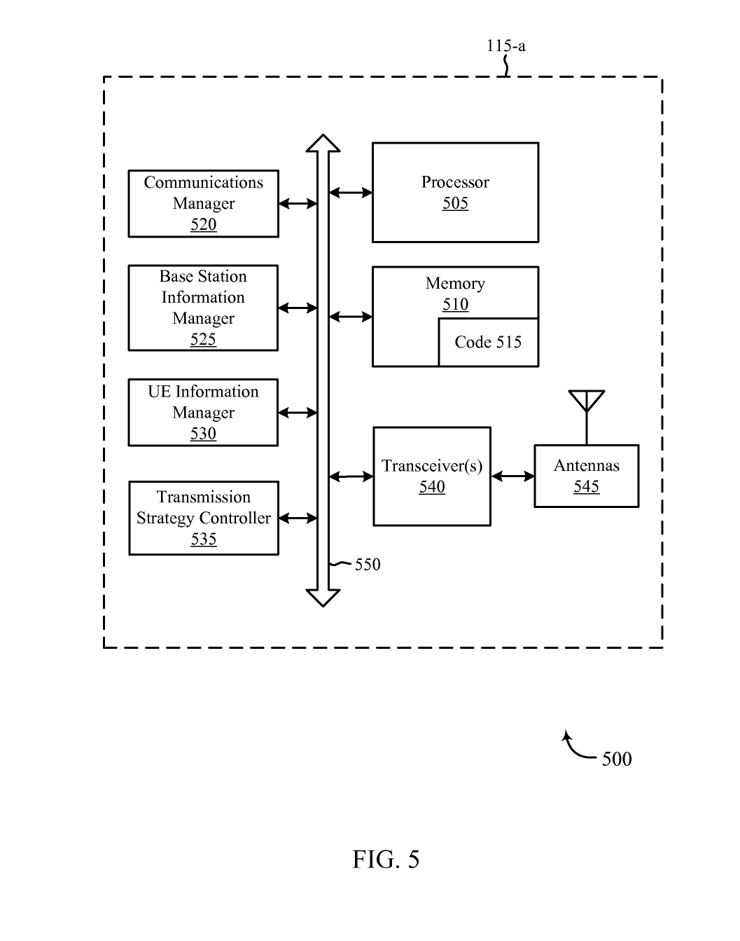

FIG. 5 shows a block diagram 500 illustrating an example of an architecture for a UE 115-a for wireless communications, in accordance with aspects of the present disclosure. The UE 115-a may have various configurations and may be included or be part of a personal computer (e.g., a laptop computer, netbook computer, tablet computer, etc.), a cellular telephone (e.g., a smartphone), a PDA, a digital video recorder (DVR), an internet appliance, a gaming console, an e-reader, etc. The UE 115-a may in some cases have an internal power supply (not shown), such as a battery, to facilitate mobile operation. The UE 115-a may be an example of various aspects of one or more of apparatus 305 described with reference to FIG. 3A, apparatus 305-a described with reference to FIG. 3B, or UEs 115 or 205 described with reference to FIGS. 1 or 2. The UE 115-a may implement one or more of the features or functions described with reference to FIGS. 1, 2, 3A 3B, and/or 4. The UE 115-a may communicate with a base station such as a base station 105 described with reference to FIG. 1, a base station 210 described with reference to FIG. 2, or an apparatus 405 described with reference to FIG. 4.

The UE 115-a may include a processor 505, a memory 510, a communications manager 520, a base station information manager 525, a UE information manager 530, a transmission strategy controller 535, at least one transceiver 540, and/or at least one antenna 545. In various examples the UE 115-a may employ beamforming techniques for receiving or transmitting signals over a radio frequency spectrum band, which in some examples may be a mmW radio frequency spectrum band. Thus, in various examples the at least one antenna 545 may refer to a plurality of antennas 545, or an antenna 545 comprising a plurality of antenna elements configured in an antenna array. Each of these components may be in communication with each other, directly or indirectly, over a bus 550.

The memory 510 may include random access memory (RAM) and/or read-only memory (ROM). The memory 510 may store computer-readable, computer-executable software/firmware code 515 containing instructions that, when executed by the processor 505, cause the UE 115-a to perform various functions described herein for wireless communications. Alternatively, the code 515 may not be directly executable by the processor 505 but may be otherwise executable to cause the UE 115-a (e.g., when compiled and executed) to perform various functions described herein.

The processor 505 may include an intelligent hardware device, e.g., a CPU, a microcontroller, an ASIC, etc. The processor 505 may process information received through the transceiver(s) 540 and/or information to be sent to the transceiver(s) 540 for transmission through the antenna(s) 545. The processor 505 may handle various aspects of wireless communications for the UE 115-a alone, or in connection with the communications manager 520, the base station information manager 525, the UE information manager 530, and/or the transmission strategy controller 535.

The transceiver(s) 540 may include a modem to modulate packets and provide the modulated packets to the antenna(s) 545 for transmission, and to demodulate packets received from the antenna(s) 545. The transceiver(s) 540 may in some cases be implemented as transmitters and separate receivers. The transceiver(s) 540 may support communications according to multiple RATs (e.g., mmW, LTE, etc.). The transceiver(s) 540 may communicate bi-directionally, via the antenna(s) 545, with a base station(s) 105 described with reference to FIG. 1.

The communications manager 520 may perform and/or control some or all of the features and/or functions described with reference to FIGS. 1, 2, 3A and/or 3B related to wireless communication with transmission strategy determination for communication with base stations 105. For example, the communications manager 520 may implement a transmission strategy that is based at least in part on information corresponding to one or more beamforming techniques supported by one or more mmW base station(s) 105, beamforming techniques supported by the UE 115-a, and possibly other information as described herein. The communications manager 520 may be an example of various aspects of the communications manager 315 or 315-a described with reference to FIGS. 3A or 3B. In some examples the communications manager 520, or portions of it, may include a processor. In various examples some or all of the functionality of the communications manager 520 may be performed or directed by the processor 505 and/or in connection with the processor 505.

The base station information manager 525 may perform and/or control some or all of the features and/or functions described with reference to FIGS. 1, 2, 3A and/or 3B related to wireless communication with transmission strategy determination for communication with base stations 105. In some examples the base station information manager 525 may perform some or all of the features of the factor identifier 330 described with reference to FIG. 3B. For example, the base station information manager 525 may collect, determine, and/or store station-specific information corresponding to one or more base stations, and may distribute station-specific information to various portions of the UE 115-a. In various examples, station-specific information may include location information, signal strength information, available frequencies, or the like. In some examples the base station information manager 525, or portions of it, may include a processor. In various examples some or all of the functionality of the base station information manager 525 may be performed or directed by the processor 505 and/or in connection with the processor 505.

The UE information manager 530 may perform and/or control some or all of the features and/or functions described with reference to FIGS. 1, 2, 3A and/or 3B related to wireless communication with transmission strategy determination for communication with base stations 105. In some examples the UE information manager 530 may perform some or all of the features of the factor identifier 330 described with reference to FIG. 3B. For example, the UE information manager 530 may collect, determine, and/or store UE-specific information corresponding to the UE 115-a, and may distribute UE-specific information to various portions of the UE 115-a. In various examples, UE-specific information may include a power level associated with a battery of the UE, a storage level of a battery of the UE, a resource availability of the UE, an application employed at the UE or a service employed at the UE, or a combination thereof. In some examples the UE information manager 530, or portions of it, may include a processor. In various examples some or all of the functionality of the UE information manager 530 may be performed or directed by the processor 505 and/or in connection with the processor 505.

The transmission strategy controller 535 may perform and/or control some or all of the features and/or functions described with reference to FIGS. 1, 2, 3A and/or 3B related to wireless communication with transmission strategy determination for communication with base stations 105. In some examples the transmission strategy controller 535 may perform some or all of the features of the transmission strategy determiner 335 described with reference to FIG. 3B. For example, the transmission strategy controller 535 may determine a transmission strategy based at least in part on information corresponding to one or more beamforming techniques supported by one or more base stations 105. In some examples, the determined transmission strategy may include a beamforming technique, and in some examples may be determined for communications with a mmW base station. In some examples the transmission strategy controller may control aspects of the transmission strategy, such as controlling aspects of beamforming employed by the UE 115-a, which in some examples may include controlling or otherwise directing portions of the transceiver(s) 540 and/or the antennas 545. In some examples the transmission strategy controller 535, or portions of it, may include a processor. In various examples some or all of the functionality of the transmission strategy controller 535 may be performed or directed by the processor 505 and/or in connection with the processor 505.

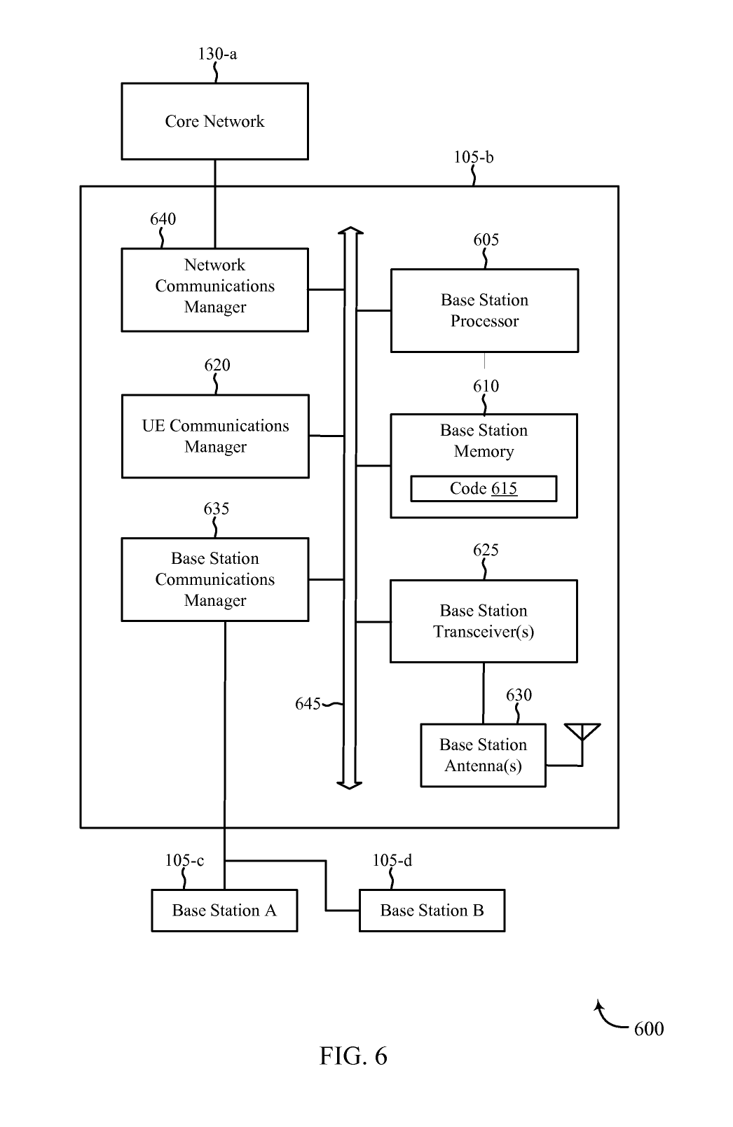

FIG. 6 shows a block diagram 600 illustrating an example of an architecture of a base station 105-b configured for use in wireless communication, in accordance with aspects of the present disclosure. In some examples, the base station 105-b may be an example of aspects of one or more of the base stations 105 described with reference to FIG. 1, base station 210 described with reference to FIG. 2, or apparatus 405 described with reference to FIG. 4. For example, the base station 105-b may be a mmW base station, which employs a mmW radio frequency spectrum band for communications with various base stations 105 and/or UEs 115 in a wireless communications system. The base station 105-b may be configured to implement or facilitate at least some of the base station and/or apparatus features and functions described with reference to FIGS. 1, 2, 3A, 3B, and/or 4.

The base station 105-b may include a base station processor 605, a base station memory 610, at least one base station transceiver (represented by base station transceiver(s) 625), at least one base station antenna (represented by base station antenna(s) 630), and/or a UE communications manager 620. The base station 105-b also may include a base station communications manager 635 and/or a network communications manager 640-b. Each of these components may be in communication with each other, directly or indirectly, over one or more buses 645.

The base station memory 610 may include random access memory (RAM) and/or read-only memory (ROM). The base station memory 610 may store computer-readable, computer-executable software/firmware code 615 containing instructions that are configured to, when executed by the base station processor 605, cause the base station 105-b to perform various functions described herein related to wireless communication (e.g., advertising information corresponding to one or more beamforming techniques supported by one or more base stations, etc.). Alternatively, the computer-readable, computer-executable software/firmware code 615 may not be directly executable by the base station processor 605 but be configured to cause the base station 105-b (e.g., when compiled and executed) to perform various of the functions described herein.

The base station processor 605 may include an intelligent hardware device, e.g., a central processing unit (CPU), a microcontroller, an ASIC, etc. The base station processor 605 may process information received through the base station transceiver(s) 625, the base station communications manager 635, the UE communications manager 620, and/or the network communications manager 640. The base station processor 605 also may process information to be sent to the base station transceiver(s) 625 for transmission through the base station antenna(s) 630, which may include transmissions to various base stations 105 or UEs 115 in a wireless communications network. The base station processor 605 may handle, alone or in connection with the UE communications manager 620, the base station communications manager 635, and/or the network communications manager 640, various aspects of selecting a base station and/or determining a transmission strategy as described herein.

The UE communications manager 620 may be configured to perform and/or control some or all of the features and/or functions described with reference to FIGS. 1 and/or 2 related to advertising of the information corresponding to beamforming techniques supported by the base station 105-b, as well as other communications with the UEs 115. For example, the UE communications manager 620 may manage or otherwise control aspects of broadcasting information corresponding to beamforming techniques supported by one or more base stations (as well as any UE transmission parameters and/or station-specific factors), which in some examples may be performed by employing performing beam sweeps of a beamforming antenna array. Alternatively or additionally, the UE communications manager 620 may manage or otherwise control the transmission of such information to base stations 105-c and/or 105-d, either via the base station transceiver(s) 625 and the base station antenna(s) 630 or via the base station communications manager 635 (e.g., through backhaul links 134). The UE communications manager 620, or portions of the UE communications manager 620, may include a processor, and/or some or all of the functions of the UE communications manager 620 may be performed by the base station processor 605 and/or in connection with the base station processor 605.

In some examples the base station communications manager 635 may manage aspects of communications with one or more other base stations 105-c and/or 105-d. For example, the network communications manager may manage aspects of a backhaul link 134 with base stations 105 or 105-a as described with reference to FIG. 1. In some examples backhaul link 134 may be a wired communications link between the base station 105-b and one or both of the other base stations 105-c or 105-d, and in some examples backhaul link 134 may be a wireless communications link employing base station transceiver(s) 625 and base station antenna(s) 630. In various examples a wireless backhaul link 134 may employ a mmW radio frequency spectrum band or another radio frequency spectrum band, such as a radio frequency spectrum band associated with an LTE communications system. In some examples the base station communications manager 635, or portions of it, may include a processor. In various examples some or all of the functionality of the base station communications manager 635 may be performed or directed by the base station processor 605 and/or in connection with the base station processor 605.

In some examples the network communications manager 640 may manage aspects of communications with a core network 130-a. For example, the network communications manager may manage aspects of a backhaul link 132 with a core network 130 as described with reference to FIG. 1. In some examples the network communications manager 640, or portions of it, may include a processor. In various examples some or all of the functionality of the network communications manager 640 may be performed or directed by the base station processor 605 and/or in connection with the base station processor 605.

In some examples the base station communications manager 635 may manage aspects of communications with one or more other base stations 105-c and/or 105-d. For example, the network communications manager may manage aspects of a backhaul link 134 with base stations 105 or 105-a as described with reference to FIG. 1. In some examples backhaul link 134 may be a wired communications link between the base station 105-b and one or both of the other base stations 105-c or 105-d, and in some examples backhaul link 134 may be a wireless backhaul link employing base station transceiver(s) 625 and base station antenna(s) 630. In various examples a wireless backhaul link 134 may employ a mmW radio frequency spectrum band or another radio frequency spectrum band, such as a radio frequency spectrum band associated with an LTE communications system. In some examples the base station communications manager 635, or portions of it, may include a processor. In various examples some or all of the functionality of the base station communications manager 635 may be performed or directed by the base station processor 605 and/or in connection with the base station processor 605.

The base station transceiver(s) 625 may include a modem configured to modulate packets and provide the modulated packets to the base station antenna(s) 630 for transmission, and to demodulate packets received from the antenna(s) 630. The base station transceiver(s) 625 may, in some examples, be implemented as one or more base station transmitters and one or more separate base station receivers. The base station transceiver(s) 625 may support communications in a first radio frequency spectrum band (e.g., mmW) and/or a second radio frequency spectrum band (e.g., LTE). The base station transceiver(s) 625 may be configured to communicate bi-directionally, via the base station antenna(s) 630, with UE(s) or base station(s), such as the UEs 115, 205, and/or 115-a described with reference to FIGS. 1, 2 and/or 4, base stations 105 described with reference to FIG. 1, and/or the apparatuses 305, 305-a, and/or 405 described with reference to FIGS. 3A, 3B, and/or 4. The base station 105-a may, for example, include multiple base station antennas 630 (e.g., an antenna array), which may employ beamforming for various wireless communications. The base station 105-b may communicate with the core network 130-a through the network communications manager 640. The base station 105-b also may communicate with other base stations, such as the base stations 105-c and 105-d, using the base station communications manager 635.

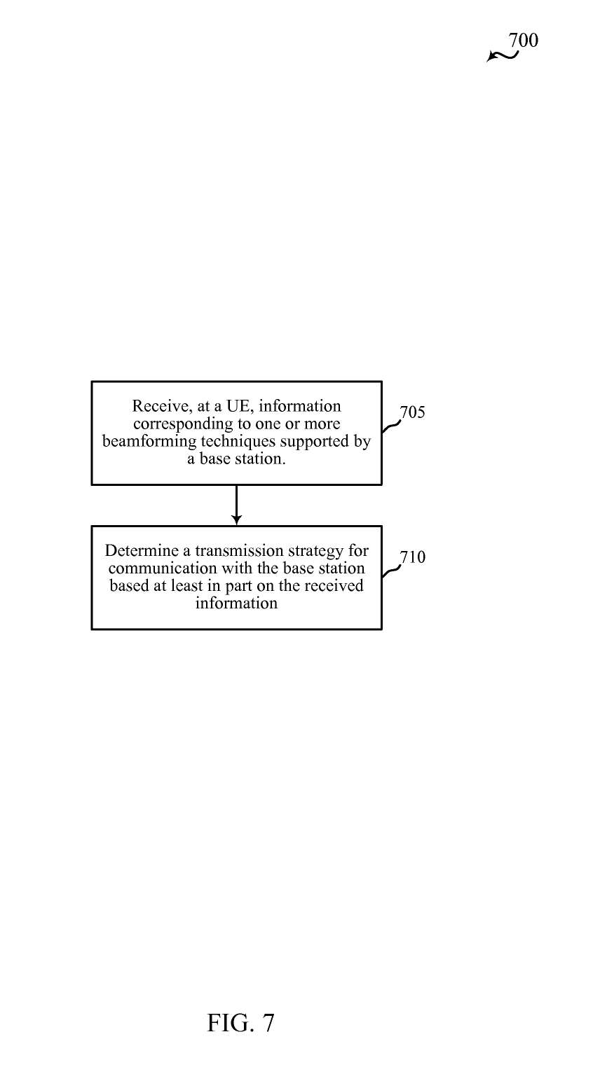

FIG. 7 shows a flowchart illustrating an example of a method 700 for wireless communication that may be implemented by a UE, in accordance with aspects of the present disclosure. For clarity, the method 700 is described with reference to aspects of one or more of the UEs 115, 205, and/or 115-a described with reference to FIGS. 1, 2 and/or 5, and/or the apparatuses 305 and/or 305-a described with reference to FIGS. 3A and/or 3B. In some examples, a UE may execute one or more sets of codes including instructions to control the functional elements of the UE to perform the functions of method 700. Additionally or alternatively, the UE may perform such function(s) described below using special-purpose hardware.

At block 705, the method 700 may involve receiving, at the UE, information corresponding to one or more beamforming techniques supported by a base station, which in some examples may be a mmW base station. As described, this may include receiving a broadcast, either from the base station or an intermediate base station. In various examples the information may be received as a transmission of a mmW radio frequency spectrum band, or in a transmission that uses a different RAT. The operation(s) at block 705 may be performed, for example, using any one or more of receivers 310 and/or communications manager 315 described with reference to FIGS. 3A or 3B, processor 505, memory 510,antenna(s) 545 and transceiver(s) 540 and/or communications manager 520 described with reference to FIG. 5, or various sub-components thereof.

At block 710, the UE may determine a transmission strategy for communication with the base station based at least in part on the received information corresponding to supported beamforming techniques. The operation(s) at block 710 may be performed using communications managers 315 described with reference to FIGS. 3A and/or 3B, processor 505, memory 510, communications manager 520, and/or transmission strategy controller 535, or various sub-components thereof.

Thus, the method 700 may provide for wireless communication in which an efficient transmission strategy may be implemented. It should be noted that the method 700 is just one implementation and that the operations of the method 700 may be rearranged or otherwise modified such that other implementations are possible.

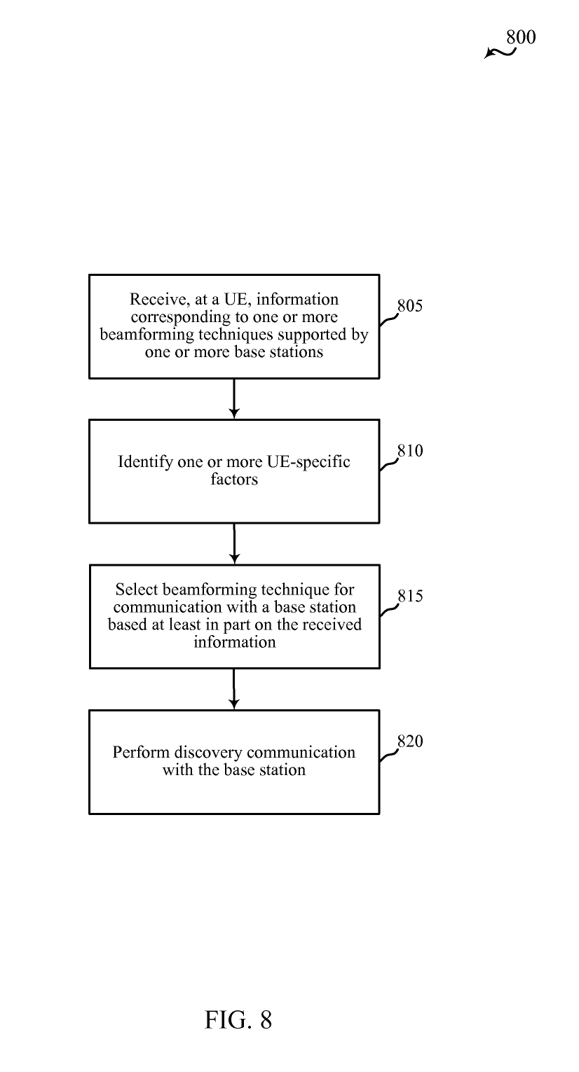

FIG. 8 shows a flowchart illustrating an example of a method 800 for wireless communication that may be implemented by a UE, in accordance with aspects of the present disclosure. For clarity, the method 800 is described with reference to aspects of one or more of the UEs 115, 205, and/or 115-a described with reference to FIGS. 1, 2 and/or 5, and/or the apparatuses 305 and/or 305-a described with reference to FIGS. 3A and/or 3B. In some examples, a UE may execute one or more sets of codes including instructions to control the functional elements of the UE to perform the functions of method 800. Additionally or alternatively, the UE may perform such function(s) described below using special-purpose hardware.

At block 805, the method 800 may involve receiving, at the UE, information corresponding to one or more beamforming techniques supported by one or more base stations, which in some examples may be one or more mmW base stations. As described, this may include receiving a broadcast, either from the base station or an intermediate base station. In various examples the information may be received as a transmission of a mmW radio frequency spectrum band, or in a transmission that uses a different RAT. The operation(s) at block 805 may be performed, for example, using any one or more of receivers 310 and/or communications managers 315 described with reference to FIGS. 3A and/or 3B, 545 transceiver(s) 540, processor 505, memory 510, and/or communications manager 520 described with reference to FIG. 5, or various sub-components thereof.

At block 810, the UE may identify UE-specific factors, which in various examples may include factors such as a power level associated with a battery of the UE, a storage level of a battery of the UE, as described herein. The operation(s) at block 810 may be performed, for example, using any one or more of communications managers 315 described with reference to FIGS. 3A and/or 3B, factor identifier 330 described with reference to FIG. 3B, processor 505, memory 510, communications manager 520, UE information manager 530, and/or transmission strategy controller 535 described with reference to FIG. 5, or various sub-components thereof.

At block 815, the UE may select a beamforming technique for communication with a base station based at least in part on the received information. In various examples, the beamforming technique may include an analog beamforming technique, a digital beamforming technique, or a hybrid beamforming technique. In some examples, the beamforming technique (as well as any other portion of a determined transmission strategy) may be additionally be determined based in part on the identified UE-specific factor(s). The operation(s) at block 815 may be performed, for example, using any one or more of communications managers 315 described with reference to FIGS. 3A and/or 3B, processor 505, memory 510, communications manager 520, transmission strategy controller 535, and/or UE information manager 530 described with reference to FIG. 5, or various sub-components thereof.

At block 820, the UE may perform a discovery communication with the base station using the selected beamforming technique (as well as other portions of a determined transmission strategy). The discovery communication may be part of a process to establish a communication link with the base station, for example, for subsequent data communications. The discovery communication may be part of a handshake procedure with the base station, an association request, or the like. The operation(s) at block 820 may be performed, for example, using any one or more of the communications managers 315 and/or transmitters 320 described with reference to FIGS. 3A and/or 3B, transceiver(s) 540, antenna(s) 545, processor 505, memory 510, communications manager 520, and/or transmission strategy controller 535 described with reference to FIG. 5, or various sub-components thereof.

Thus, the method 800 may provide for wireless communication in which an efficient transmission strategy may be implemented, and used for discovery and/or association with the base station. It should be noted that the method 800 is just one implementation and that the operations of the method 800 may be rearranged or otherwise modified such that other implementations are possible.

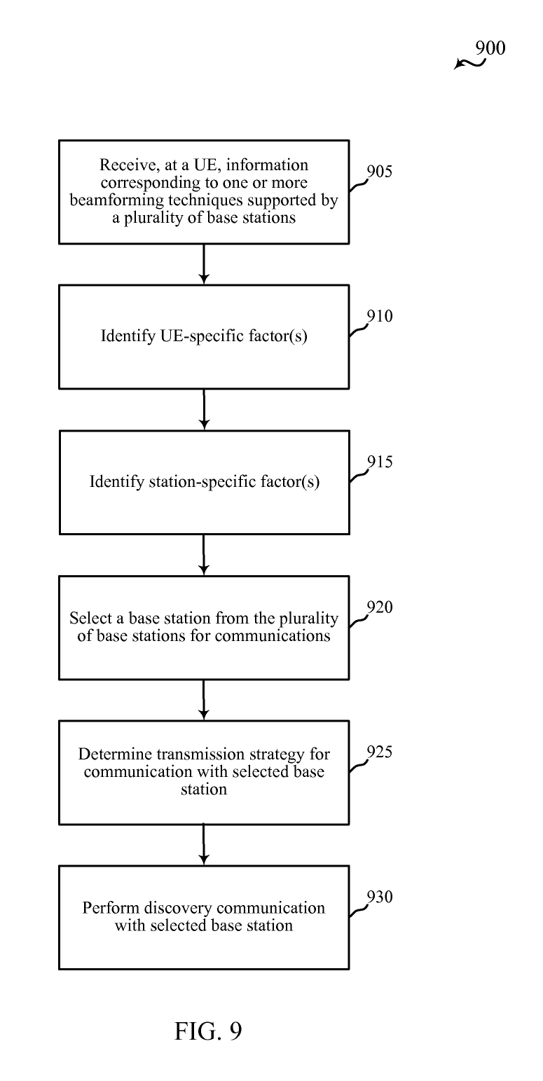

FIG. 9 shows a flowchart illustrating an example of a method 900 for wireless communication that may be implemented by a UE, in accordance with aspects of the present disclosure. For clarity, the method 900 is described with reference to aspects of one or more of the UEs 115, 205, and/or 115-a described with reference to FIGS. 1, 2 and/or 5, and/or the apparatuses 305 and/or 305-a described with reference to FIGS. 3A and/or 3B. In some examples, a UE may execute one or more sets of codes including instructions to control the functional elements of the UE to perform the functions of method 900. Additionally or alternatively, the UE may perform such function(s) described below using special-purpose hardware.

At block 905, the method 900 may involve receiving, at the UE, information corresponding to one or more beamforming techniques supported by one or more base stations, which in some examples may be one or more mmW base stations. As described, this may include receiving a broadcast, either from the base station or an intermediate base station. In various examples the information may be received as a transmission of a mmW radio frequency spectrum band, or in a transmission that uses a different RAT. The operation(s) at block 905 may be performed, for example, using any one or more of receivers 310 and/or communications managers 315 described with reference to FIGS. 3A and/or 3B, antenna(s) 545 transceiver(s) 540, processor 505, memory 510, and/or communications manager 520 described with reference to FIG. 5, or various sub-components thereof.

At block 910, the UE may identify UE-specific factors, which in various examples may include factors such as a power level associated with a battery of the UE, a storage level of a battery of the UE as described herein. The operation(s) at block 910 may be performed, for example, using any one or more of communications managers 315 described with reference to FIGS. 3A and/or 3B, factor identifier 330 described with reference to FIG. 3B, processor 505, memory 510, communications manager 520, UE information manager 530, and/or transmission strategy controller 535 described with reference to FIG. 5, or various sub-components thereof.

At block 915, the UE may identify station-specific factors, which in various examples may include factors such as station location information, signal strength information, available frequencies and the like. The operation(s) at block 910 may be performed, for example, using any one or more of communications managers 315 described with reference to FIGS. 3A and/or 3B, factor identifier 330 described with reference to FIG. 3B, processor 505, memory 510, communications manager 520, base station information manager 525, and/or transmission strategy controller 535 described with reference to FIG. 5, or various sub-components thereof.

At block 920, the UE may select a base station from the plurality of base stations for communications. The selection may be based at least in part on the information corresponding to beamforming techniques supported by the plurality of base stations, as well as, where applicable, any identified UE-specific factor(s) and /or any station-specific factor(s). The operation(s) at block 920 may be performed, for example, using any one or more of communications managers 315 described with reference to FIGS. 3A and/or 3B, factor identifier 330 described with reference to FIG. 3B, processor 505, memory 510, communications manager 520, UE information manager 530, base station information manager 525, and/or transmission strategy controller 535 described with reference to FIG. 5, or various sub-components thereof.

At block 925, the UE may determine a transmission strategy for communication with the base station based at least in part on the received information corresponding to supported beamforming techniques. For example, in various examples, the UE may select a beamforming technique, such as an analog beamforming technique, a digital beamforming technique, or a hybrid beamforming technique. In various examples, the determination may additionally be based on any identified UE-specific factors and/or identified station-specific factors. The operation(s) at block 925 may be performed using communications managers 315 described with reference to FIGS. 3A and/or 3B, processor 505, memory 510, communications manager 520, and/or transmission strategy controller 535, or various sub-components thereof.

At block 930, the UE may perform a discovery communication with the base station using the selected beamforming technique (as well as other portions of a determined transmission strategy). The discovery communication may be part of a process to establish a communication link with the base station, for example, for subsequent data communications. The discovery communication may be part of a handshake procedure with the base station, an association request, or the like. The operation(s) at block 930 may be performed, for example, using any one or more of the communications managers 315 and/or transmitters 320 described with reference to FIGS. 3A and/or 3B, transceiver(s) 540, antenna(s) 545, processor 505, memory 510, communications manager 520, and/or transmission strategy controller 535 described with reference to FIG. 5, or various sub-components thereof.

Thus, the method 900 may provide for wireless communication in which a suitable base station may be selected and an efficient transmission strategy with the selected base station may be implemented. It should be noted that the method 900 is just one implementation and that the operations of the method 900 may be rearranged or otherwise modified such that other implementations are possible.

In some examples, aspects from two or more of the methods 700, 800, or 900 described with reference to FIGS. 7, 8, or 9 may be combined. It should be noted that the methods 700, 800, and 900 are just example implementations, and that the operations of the methods 700, 800, or 900 may be rearranged or otherwise modified such that other implementations are possible.

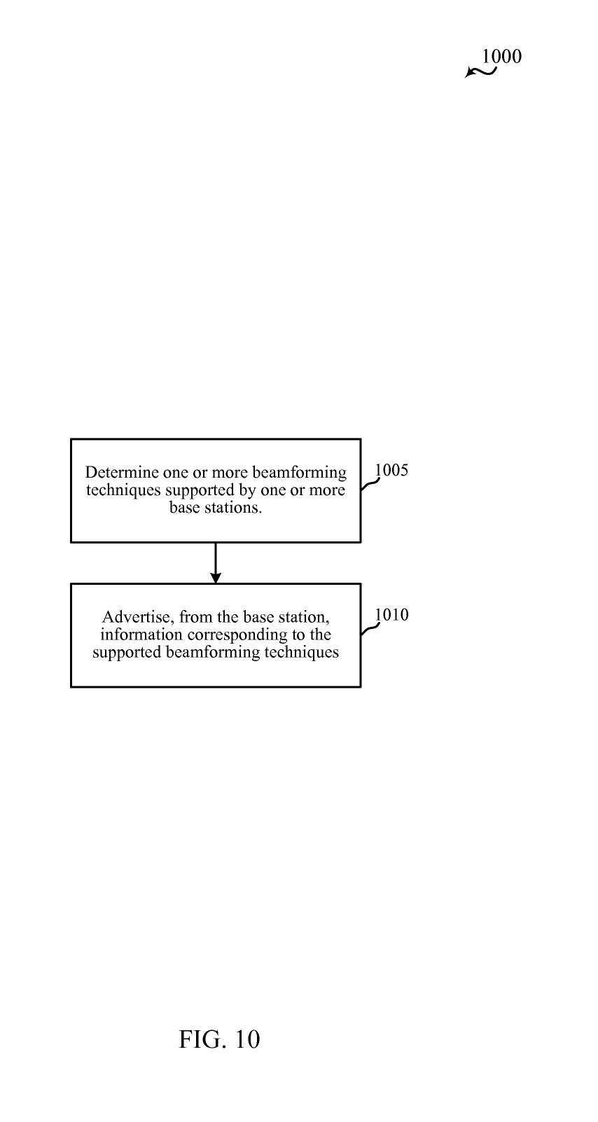

FIG. 10 shows a flowchart illustrating an example of a method 1000 for wireless communication that may be implemented by a base station, in accordance with aspects of the present disclosure. For clarity, the method 1000 is described with reference to aspects of one or more of the base stations 105, 210 and/or 105-b described with reference to FIGS. 1, 2 and/or 5, or apparatus 405 described with reference to FIG. 4, which in various examples may refer to a base station employing a mmW radio frequency spectrum band for communications with one or more UEs 115. In some examples, a base station may execute one or more sets of codes to control the functional elements of the base station to perform the functions of method 1000. Additionally or alternatively, the base station may perform such function(s) described below using special-purpose hardware.

At block 1005, the method 1000 may include determining one or more beamforming techniques supported by one or more base stations. In various examples the beamforming techniques may be analog, digital, and/or hybrid beamforming techniques, and in some examples may refer to beamforming techniques applicable to a mmW radio frequency spectrum band. In some examples, the one or more beamforming techniques may be those supported by the base station itself. In some examples, the information may correspond to beamforming techniques supported by a plurality of base stations 105 of a wireless communications system, which may or may not include information regarding the base station performing the determination. The operation(s) at block 1005 may be performed, for example, using any one or more of receiver 410 and/or communications manager 415 described with reference to FIG. 4, base station processor 605, base station memory 610, antenna(s) 630, base station transceiver(s) 625, network communications manager 640, base station communications manager 635 described with reference to FIG. 6, or various sub-components thereof.

At block 1010, the base station may advertise information corresponding to the one or more supported beamforming techniques. In various examples, as described herein, the advertising may employ a mmW radio frequency spectrum band such as a mmW broadcast and/or a mmW beam sweep, or may employ some other radio frequency spectrum band, such as a radio frequency spectrum band associated with an LTE communications system. The operation(s) at block 1010 may be performed, for example, using any one or more of transmitter 420 and/or communications manager 415 described with reference to FIG. 4, base station processor 605, base station memory 610, antenna(s) 630, base station transceiver(s) 625, UE communications manager 620, network communications manager 640, base station communications manager 635 described with reference to FIG. 6, or various sub-components thereof.

Thus, the method 1000 may provide for wireless communication in which a base station advertises information corresponding to supported beamforming techniques. It should be noted that the method 1000 is just one implementation and that the operations of the method 1000 may be rearranged or otherwise modified such that other implementations are possible.

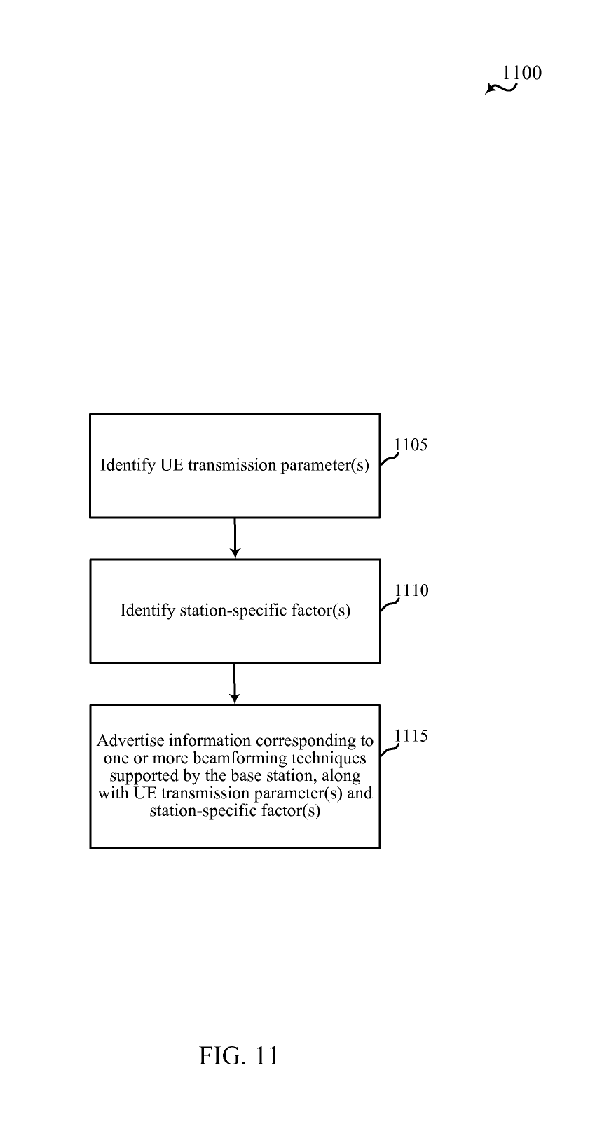

FIG. 11 shows a flowchart illustrating an example of a method 1100 for wireless communication that may be implemented by a base station, in accordance with aspects of the present disclosure. For clarity, the method 1000 is described with reference to aspects of one or more of the base stations 105, 210 and/or 105-b described with reference to FIGS. 1, 2 and/or 5, or apparatus 405 described with reference to FIG. 4, which in various examples may refer to a base station employing a mmW radio frequency spectrum band for communications with one or more UEs 115. In some examples, a base station may execute one or more sets of codes to control the functional elements of the base station to perform the functions of method 1000. Additionally or alternatively, the base station may perform such function(s) described below using special-purpose hardware

At block 1105, a base station may identify UE transmission parameters that are recommended for a UE to use for communications with the base station. At block 1110, the base station may identify station-specific factors that a UE may use for selecting the base station from among a plurality of base stations and/or for determining a transmission strategy for communication with the base station. The operation(s) at block 1105 and/or block 1110 may be performed, for example, using any one or more of receiver 410 and/or communications manager 415 described with reference to FIG. 4, base station processor 605, base station memory 610, antenna(s) 630, base station transceiver(s) 625, network communications manager 640, base station communications manager 635 described with reference to FIG. 6, or various sub-components thereof.

At block 1115, the base station may advertise information corresponding to the one or more supported beamforming techniques supported by the base station, along with UE transmission parameter(s) and station-specific factor(s). In various examples, as described herein, the advertising may employ a mmW radio frequency spectrum band such as a mmW broadcast and/or a mmW beam sweep, or may employ some other radio frequency spectrum band, such as a radio frequency spectrum band associated with an LTE communications system. The operation(s) at block 1115 may be performed, for example, using any one or more of transmitter 420 and/or communications manager 415 described with reference to FIG. 4, base station processor 605, base station memory 610, antenna(s) 630, base station transceiver(s) 625, UE communications manager 620, network communications manager 640, base station communications manager 635 described with reference to FIG. 6, or various sub-components thereof.

Thus, the method 1100 may provide for wireless communication in which a base station advertises information corresponding to one or more beamforming techniques supported by the base station, along with additional information. It should be noted that the method 1100 is just one implementation and that the operations of the method 1100 may be rearranged or otherwise modified such that other implementations are possible.

In some examples, aspects from the methods 1000 or 1100 described with reference to FIGS. 10 or 11 may be combined. It should be noted that the methods 1000 and 1100 are just example implementations, and that the operations of the methods 1000 or 1100 may be rearranged or otherwise modified such that other implementations are possible.

As described, the UE may determine the transmission strategy based on factors in addition to the information corresponding to one or more beamforming techniques supported by one or more base station(s). Such factors may include, but are not limited to UE-specific factors or station-specific factors. For example, a storage level of a UE battery may be considered, which in various examples may correspond to an estimate and/or measurement of an amount of energy remaining in a UE battery and/or a percentage of a battery capacity remaining in a UE battery. In some examples a power level associated with a UE battery may be considered, which in various examples may be related to an amount of power draw that a UE battery can support, or some other limit for UE battery power associated with the transmission strategy. In some examples, such as when the UE is in a power crunch scenario (e.g., relatively low energy remaining in a UE battery, or relatively low power being available from a UE battery, or some other energy or power constraint at the UE), the battery storage level or battery power level may be considered as an important factor in determining a suitable transmission strategy, because various transmission techniques may rely on, or affect an amount of energy remaining in a UE battery.

The UE may have multiple radio frequency (RF) chains or more than one sub-array for signaling (such as a broadcast request signal to nearby base station(s) during an initial discovery period and hand-shaking procedure). The determination of the transmission strategy also may take into account such resource or antenna availability/capability at the UE.

The UE may have different types of applications/services in operation at a given time (e.g., low latent or high latent applications), which may influence the determination of the transmission strategy. Even though mmW wireless networks mainly may be designed for high data rate applications, still some may require a certain minimal latency, whereas latency may not be a concern for others. For low latent applications, the UE may benefit from digital beam forming as allowing simultaneous transmission via multiple beams.

Such UE-specific factors may also be considered when selecting a base station from among a plurality of base stations, including those base stations for which the UE has received information corresponding to one or more supported beamforming techniques.

According to the techniques described herein, a UE may make use of information corresponding to one or more beamforming techniques supported by one or more base stations to provide wireless communications in a more efficient way, and may select a base station and/or determine a transmission strategy accordingly, which may result in higher performance of the UE and may reduce resource/power consumption.

Although the techniques described herein may be used for mmW-based wireless communications systems, such techniques may be used for various other wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), Institute of Electrical and Electronics Engineers (IEEE) 802.11 (WiFi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over an unlicensed and/or shared bandwidth. The descriptions may refer to an LTE/LTE-A system for purposes of example, and LTE terminology is used in much of the description above. However, it should be understood that the described techniques are applicable beyond LTE/LTE-A applications.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor also may be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions also may be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for wireless communication, comprising:
receiving, at a user equipment (UE), information corresponding to one or more beamforming techniques supported by a first millimeter wavelength (mmW) base station; and
determining a transmission strategy for communication with the first mmW base station based at least in part on the received information.

2. The method of claim 1, wherein the one or more beamforming techniques supported by the first mmW base station comprise an analog beamforming technique, a digital beamforming technique, or a hybrid beamforming technique, or a combination thereof.

3. The method of claim 1, wherein determining the transmission strategy for communication with the first mmW base station comprises:
selecting one of an analog beamforming technique, a digital beamforming technique, or a hybrid beamforming technique for transmission to the first mmW base station.

4. The method of claim 1, further comprising:
performing a discovery communication with the first mmW base station using the determined transmission strategy.

5. The method of claim 1, further comprising:
identifying at least one UE-specific factor; and
wherein determining the transmission strategy for communication with the first mmW base station is based at least in part on the at least one UE-specific factor.

6. The method of claim 5, wherein the at least one UE-specific factor comprises:
a power level associated with a battery of the UE, a storage level of a battery of the UE, a resource availability of the UE, an application employed at the UE or a service employed at the UE, or a combination thereof.

7. The method of claim 6, wherein the resource availability of the UE comprises:
an antenna availability or a radio frequency chain availability, or a combination thereof.

8. The method of claim 1, further comprising:
receiving at least one transmission parameter for the UE from the first mmW base station; and
wherein the transmission strategy for communication with the first mmW base station is determined based at least in part on the at least one transmission parameter.

9. The method of claim 1, further comprising
receiving at least one other station-specific factor; and
wherein the transmission strategy for communication with the first mmW base station is based at least in part on the at least one other station-specific factor.

10. The method of claim 1, wherein receiving information corresponding to one or more beamforming techniques supported by the first mmW base station comprises:
receiving a broadcast transmission from the first mmW base station.

11. The method of claim 1, wherein receiving information corresponding to one or more beamforming techniques supported by the first mmW base station comprises:
receiving a transmission employing a radio access technology other than mmW.

12. The method of claim 1, further comprising:
receiving, at the UE, information corresponding to one or more beamforming techniques supported by a second mmW base station; and
selecting the first mmW base station for communication therewith based at least in part on the information corresponding to one or more beamforming techniques supported by the first mmW base station and the information corresponding to one or more beamforming techniques supported by the second mmW base station.

13. An apparatus for wireless communication, comprising:
a processor;
memory in electronic communication with the processor; and
instructions stored in the memory and executable by the processor to cause the apparatus to:
receive, at a user equipment (UE), information corresponding to one or more beamforming techniques supported by a first millimeter wavelength (mmW) base station; and
determine a transmission strategy for communication with the first mmW base station based at least in part on the received information.

14. The apparatus of claim 13, wherein the one or more beamforming techniques supported by the first mmW base station comprise an analog beamforming technique, a digital beamforming technique, or a hybrid beamforming technique, or a combination thereof.

15. The apparatus of claim 13, wherein the instructions are executable by the processor to cause the apparatus to:
select one of an analog beamforming technique, a digital beamforming technique, or a hybrid beamforming technique for transmission to the first mmW base station.

16. The apparatus of claim 13, wherein the instructions are executable by the processor to cause the apparatus to:
perform a discovery communication with the first mmW base station using the determined transmission strategy.

17. The apparatus of claim 13, wherein the instructions are executable by the processor to cause the apparatus to:
identify at least one UE-specific factor; and
determine the transmission strategy based at least in part on the at least one UE-specific factor.

18. The apparatus of claim 13, wherein the instructions are executable by the processor to cause the apparatus to:
receive at least one transmission parameter for the UE from the first mmW base station; and
determine the transmission strategy for communication with the first mmW base station based at least in part on the at least one transmission parameter.

19. The apparatus of claim 13, wherein the instructions are executable by the processor to cause the apparatus to:
receive at least one other station-specific factor; and
determine the transmission strategy for communication with the first mmW base station based at least in part on the at least one other station-specific factor.

20. The apparatus of claim 13, wherein the instructions are executable by the processor to cause the apparatus to:
receive the information corresponding to one or more beamforming techniques supported by the first mmW base station by receiving a transmission employing a radio access technology other than mmW.

21. The apparatus of claim 13, wherein the instructions are executable by the processor to cause the apparatus to:
receive, at the UE, information corresponding to one or more beamforming techniques supported by a second mmW base station; and
selecting the first mmW base station for communication therewith based at least in part on the information corresponding to one or more beamforming techniques supported by the first mmW base station and the information corresponding to one or more beamforming techniques supported by the second mmW base station.

22. A method for wireless communication, comprising:
advertising, from a millimeter wavelength (mmW) base station, information corresponding to one or more beamforming techniques supported by the mmW base station.

23. The method of claim 22, wherein the one or more beamforming techniques supported by the mmW base station comprise an analog beamforming technique, a digital beamforming technique, or a hybrid beamforming technique, or a combination thereof.

24. The method of claim 22, wherein advertising information corresponding to one or more beamforming techniques supported by the mmW base station comprises:
transmitting the information corresponding to one or more beamforming techniques supported by the mmW base station by employing a radio access technology other than mmW.

25. The method of claim 22, wherein advertising information corresponding to one or more beamforming techniques supported by the mmW base station comprises:
broadcasting the information corresponding to one or more beamforming techniques supported by the mmW base station.

26. The method of claim 25, wherein advertising information corresponding to one or more beamforming techniques supported by the mmW base station comprises:
the mmW base station performing a beam sweep.

27. The method of claim 22, further comprising:
receiving a discovery communication from a UE, the discovery communication having a transmission strategy based at least in part on the advertised information corresponding to one or more beamforming techniques supported by the mmW base station.

28. An apparatus for wireless communication, comprising:
a processor;
memory in electronic communication with the processor; and
instructions stored in the memory and executable by the processor to cause the apparatus to:
advertise, from a millimeter wavelength (mmW) base station, information corresponding to one or more beamforming techniques supported by the mmW base station.

29. The apparatus of claim 28, wherein the instructions are executable by the processor to cause the apparatus to:
transmit the information corresponding to one or more beamforming techniques supported by the mmW base station by employing a radio access technology other than mmW.

30. The apparatus of claim 28, wherein the instructions are executable by the processor to cause the apparatus to:
broadcast the information corresponding to one or more beamforming techniques supported by the mmW base station.
